(19) United States
(12) Patent Application Publication
(10) Pub. No.: US 2004/0051699 A1
(43) Pub. Date: Mar. 18, 2004

(54) Transparent touch panel and method of manufacturing the touch panel

(76) Inventors: Koji Tanabe, Katano-shi (JP); Kenichi Takabatake, Ibaraki-shi (JP); Tetsuo Inazuka, Hirakata-shi (JP); Kenichi Matsumoto, Hirakata-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/399,507

(22) PCT Filed: Aug. 7, 2002
(86) PCT No.: PCT/JP02/08055

(30) Foreign Application Priority Data
Aug. 21, 2001 (JP) 2001-250055

(51) Int. Cl. G09G 5/00

(52) U.S. Cl. 345/173

(57) ABSTRACT

An easy-to-assemble and inexpensive TTP used in various electronic apparatus for switching the operation. A method for manufacturing the TTP is also disclosed. Lower substrate 25 is provided with a pair of connection electrodes 29 and 30 opposing to upper lead-out sections 23A and 24A; one end of which connection electrodes, or the left connection parts 29A, 30A, are glued and connected to upper lead-out sections 23A, 24A, while the other end, or the right connection parts 29B, 30B and lower lead-out sections 27A, 28A are glued and connected to wiring patterns 32, 33, 34 and 35 to implement a finished TTP.

### TECHNICAL FIELD

The present invention relates to a transparent touch panel used for switching the operation in various kinds of electronic apparatus, and a method for manufacturing the transparent touch panel.

### BACKGROUND ART

The function of recent electronic apparatus has become diversified and more sophisticated. An increasing number of such electronic apparatus employs a transparent touch panel (hereinafter referred to as TTP) in the front of an LCD or the like display devices disposed in the apparatus as means for switching the operation. An operator viewing a display screen through a TTP can switch operation of the apparatus by selecting one of items among the letters, symbols or pictograms shown in the screen representing respective functions and designating a desired function through the TTP. A conventional TTP used for the purpose is described in the following with reference to the drawings in FIG. 4 through FIG. 6. FIG. 4 shows plan view of a conventional TTP. FIG. 5A and FIG. 5B show plan view of upper substrate and that of lower substrate, respectively, of a conventional TTP. Referring to FIG. 5A, the upper substrate 1 is made with a transparent film such as polyethylene terephthalate(PET), polycarbonate(PC), etc. A transparent upper conductive layer 2 is provided on the reverse surface of the transparent film. Transparent conductive layer 2 is formed of a transparent indium oxide-tin oxide, or the like metal oxide through vacuum deposition, sputtering or the like method.

A pair of upper electrodes 3 and 4 are formed by printing a conductive paste of silver, carbon, etc. As shown in FIG. 5A, the upper electrodes 3 and 4 are provided at both sides of upper conductive layer 2; by first removing the upper conductive layer 2 selectively by means of etching or laser beam cutting, and then the upper electrode is formed stretching in the removed lane on upper substrate 1. Respective ends of the upper electrodes form upper lead-out sections 3A and 4A.

Referring to FIG. 5B, a transparent lower conductive layer 6 is formed in the same manner as the upper conductive layer 2, on the upper surface of a transparent lower substrate 5 made of glass, acrylic resin, PC resin, etc. A pair of lower electrodes 7 and 8 are formed along the both sides of lower conductive layer 6 in the direction perpendicular to upper electrodes 3, 4 of upper conductive layer 2. Respective ends of the lower electrodes form lower lead-out sections 7A and 8A. A plurality of dot spacers (not shown in the drawing) is provided at a regular interval on the upper surface of lower conductive layer 6, for the purpose of maintaining a certain specific clearance with respect to the upper conductive layer 2. The dot spacers are made of epoxy resin, silicone resin or the like insulating resin.

Upper substrate 1 and lower substrate 5 are attached together at the outer circumference using a frame-shaped spacer 9 which has an adhesive on both of the upper and lower surfaces, as shown in FIG. 4. Thus, the upper conductive layer 2 and the lower conductive layer 6 are disposed opposing to each other with a certain specific gap. In the lead-out sections of upper substrate 1 and lower substrate 5, there is a wiring substrate 10 having a plurality of wiring patterns on the lower surface sandwiched by the substrates.

Referring to FIG. 6, an anisotropic conductive adhesive 11 is applied in the space formed by respective lead-out sections of upper and lower substrates 1, 5 and the wiring pattern of wiring board 10. Upper lead-out sections 3A and 4A of upper substrate 1 are connected respectively to wiring patterns 12A and 13A disposed on the upper surface of wiring substrate 10.

The wiring patterns 12A, 13A are connected via through holes filled with a conductive agent to wiring patterns 12, 13 disposed on the lower surface. Lower lead-out sections 7A, 8A of lower substrate 5 are connected to wiring patterns 14, 15 disposed on the lower surface of wiring substrate 10 by the anisotropic conductive adhesive 11. In the above-configured TTP, each of the wiring patterns of wiring substrate 10 is connected with a detection circuit of an electronic apparatus via a connector or other connecting means. When upper substrate 1 is pressed from the above at a certain location with a finger tip, pen, etc., the upper substrate 1 bends, and upper conductive layer 2 makes contact with lower conductive layer 6 at the location. The pressed location is identified at the detection circuit, based on the respective resistance ratio between upper electrodes 3, 4 and lower electrodes 7, 8.

In a conventional TTP as described in the above, a wiring substrate 10 is disposed between upper substrate 1 and lower substrate 5, and three constituent parts, viz. the upper and lower lead-out sections and both surfaces of the wiring patterns, need to be assembled after they are precisely aligned with each other. Therefore, the operating productivity is low, and it takes a long time for the assembly.

The wiring substrate 10, in which the wiring patterns 12A, 13A disposed on the upper surface are connected with the wiring patterns 12, 13 on the reverse surface via through holes, is expensive. Furthermore, when heating anisotropic conductive adhesive 11 for implementing a connection, the stacked structure of three constituent components, viz. upper substrate 1, lower substrate 5 and wiring substrate 10, readily causes a temperature difference within the stacked structure, which leads to a dispersion in the strength of adhesion and connection.

### DISCLOSURE OF INVENTION

Addressing the above-described problems, the present invention offers a transparent touch panel having the following structure.

A transparent touch panel which comprises a transparent upper substrate having on the reverse surface a transparent upper conductive layer and an upper electrode extending along both sides of the upper conductive layer, extension of which electrodes forming a pair of upper lead-out sections at an end; a transparent lower substrate having on the upper surface a transparent lower conductive layer opposing to the upper conductive layer with a certain specific clearance and a lower electrode extending along both sides of the lower conductive layer in the direction perpendicular to the upper conductive layer, extension of which electrodes forming a pair of lower lead-out sections at an end; and a wiring substrate provided with a plurality of wiring patterns disposed on the reverse surface, which wiring patterns being glued and connected with the upper substrate or the lower substrate with an anisotropic conductive adhesive. In which touch panel, the lower substrate is provided with a pair of connection electrodes opposing to the upper lead-out sections; the connection electrodes being glued and connected at one end to the upper lead-out sections, while the other end of the connection electrodes and the lower lead-out sections to the wiring patterns of the wiring substrate.

### BRIEF DESCRIPTION OF THE DRAWINGS

FIG. 1 shows plan view of a TTP in accordance with an exemplary embodiment of the present invention.

FIG. 2A shows plan view of upper substrate of a TTP in accordance with an exemplary embodiment of the present invention.

FIG. 2B shows plan view of lower substrate of a TTP in accordance with an exemplary embodiment of the present invention.

FIG. 3 shows cross sectional view of a TTP in accordance with an exemplary embodiment of the present invention.

FIG. 4 shows plan view of a conventional TTP.

FIG. 5A shows plan view of upper substrate of a conventional TTP.

FIG. 5B shows plan view of lower substrate of a conventional TTP.

FIG. 6 shows cross sectional view of a conventional TTP.

### BEST MODE FOR CARRYING OUT THE INVENTION

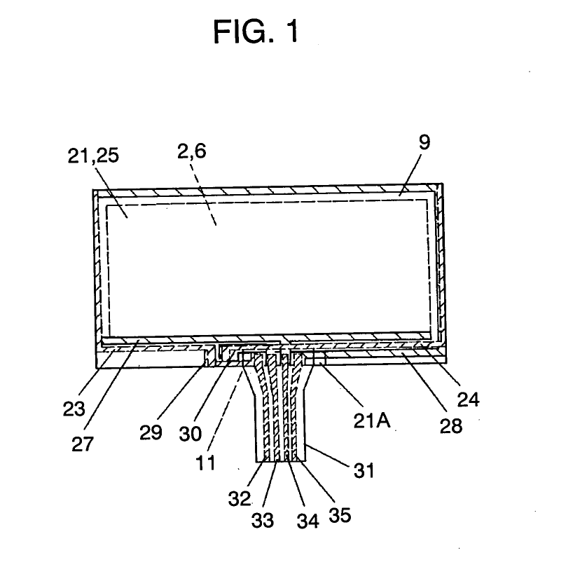

Exemplary embodiment of the present invention is described with reference to the drawings, FIG. 1 through FIG. 3. In the drawings, those portions having the same structure as those in the conventional technologies are represented by using the same symbols, and the description on which portions will be simplified. The drawings are intended to offer the concepts of invention, they do not illustrate actual positions and dimensions.

(Exemplary Embodiment)

Referring to FIG. 1, an upper substrate 21 is made of a transparent film of PET, PC or the like material having an approximate thickness of 150-200 μm. On the reverse surface of which substrate, a transparent upper conductive layer 2 is provided by sputtering a material of an indium oxide-tin oxide system. Besides the above material, metals such as gold, silver, platinum, palladium, rhodium, etc., and metal oxides such as tin oxide, indium oxide, antimony oxide, etc. can be used as a material for the transparent conductive layer. The pair of upper electrodes 23, 24 is formed by printing a conductive paste of silver, carbon, etc.

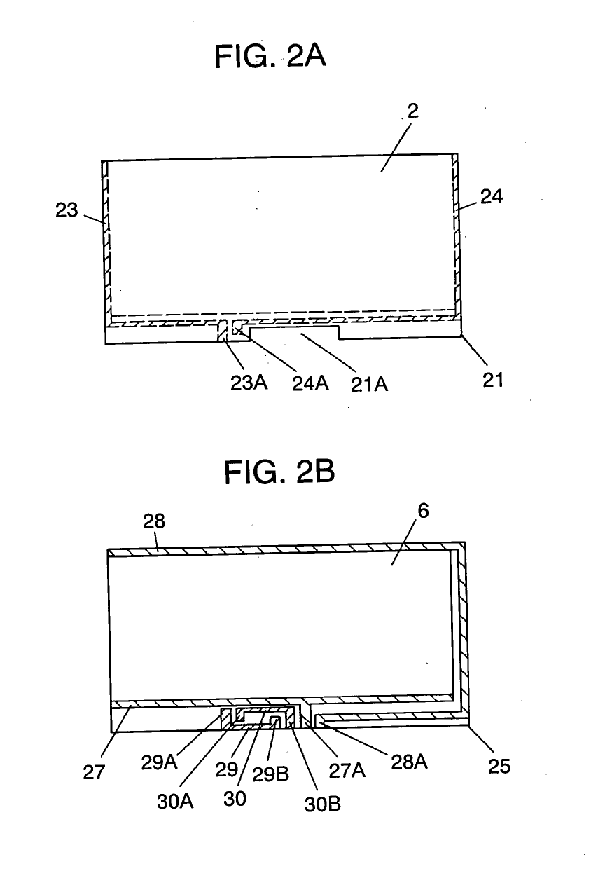

Upper electrodes 23, 24 are provided by first removing the upper conductive layer 2 selectively at both sides by means of etching or laser beam cutting, and then the electrodes are formed extending in the removed lanes on the upper substrate 21, as shown in FIG. 2A. Extension of which electrodes form a pair of upper lead-out sections 23A and 24A at an end.

As shown in FIG. 2B, a transparent lower substrate 25 made of glass, acrylic resin, PC resin, etc. is provided, in the same manner as the upper conductive layer 2, with a transparent lower conductive layer 6 formed on the upper surface. A pair of lower electrodes 27, 28 is provided extending from both sides of lower conductive layer 6, which sides being perpendicular to the upper electrodes 23, 24 of upper conductive layer 2. Extension of which electrodes form a pair of lower lead-out sections 27A and 28A at an end.

Next, a pair of connection electrodes 29, 30 is provided on lower substrate 25 by printing a conductive paste of silver, carbon, etc., which connection electrodes being independent of the lower electrodes 27, 28. The respective connection electrodes are provided at one ends, which are opposing to upper lead-out sections 23A, 24A, with the left connection parts 29A, 30A; while the other ends, which are forming the right connection parts 29B, 30B, are disposed side by side with the lower lead-out sections 27A, 28A. A plurality of dot spacers (not shown) is provided at a certain specific interval on the upper surface of lower conductive layer 6, for keeping a certain specific clearance against upper conductive layer 2. The dot spacers are made of epoxy resin, silicone resin or other insulating resin. The upper substrate 21 and the lower substrate 25 are glued together at the outer circumference using a frame-shaped spacer 9 having an adhesive on both of the upper and lower surfaces, as shown in FIG. 1, so that upper conductive layer 2 and lower conductive layer 6 oppose to each other with a certain specific clearance in between.

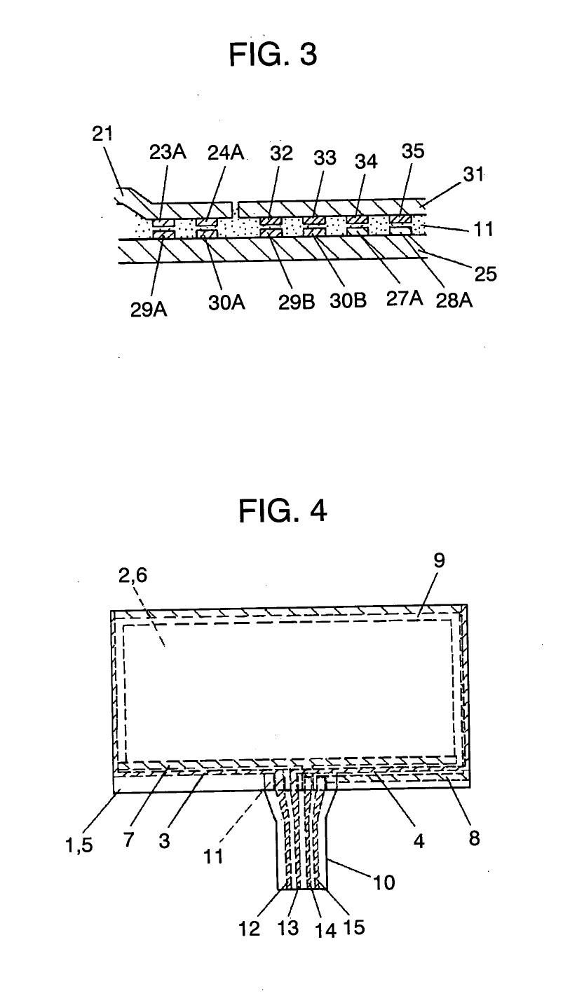

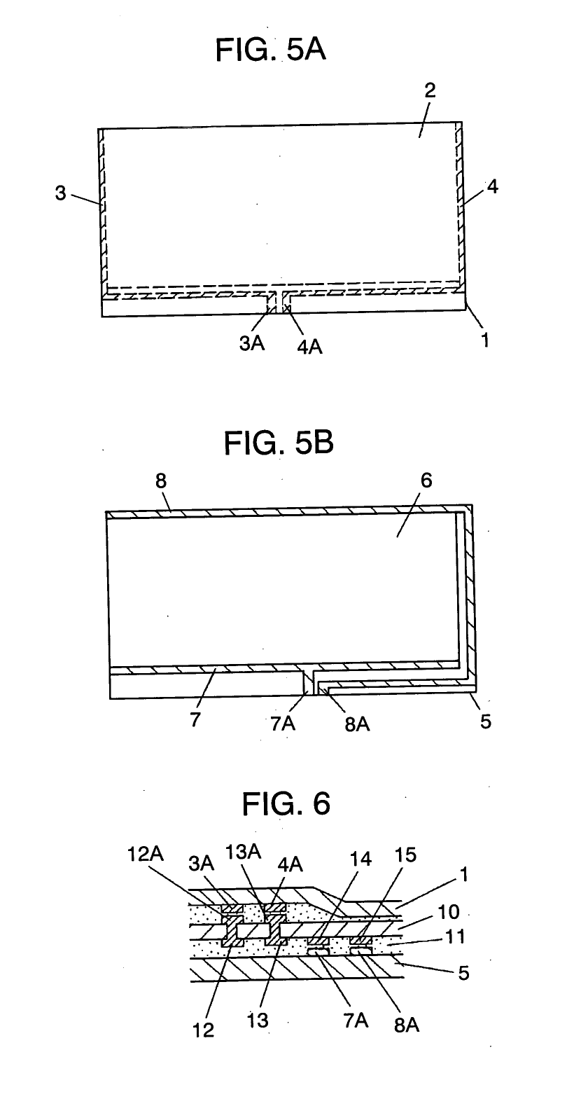

Upper substrate 21 is provided with a cut 21A for an area opposing to lower lead-out sections 27A, 28A and the right connection parts 29B, 30B. A wiring substrate 31 having a plurality of wiring patterns on the reverse surface is placed in the cut 21A. As shown in FIG. 3, a cross sectional view, an anisotropic conductive adhesive 11 is applied in a space formed by respective lead-out sections of upper substrate 21 and lower substrate 25 and wiring patterns of wiring board 31. Upper lead-out sections 23A, 24A of upper substrate 21 are glued and connected to the left connection parts 29A, 30A of lower substrate 25, respectively. The anisotropic conductive adhesive 11 is produced by dispersing metal particles, metal, or conductive powder made of resin particles plated with a precious metal in a synthetic resin such as chloroprene rubber, polyester resin, epoxy resin, etc.

Wiring patterns 32, 33 disposed on the reverse surface of wiring substrate 31 are glued and connected to the right connection parts 29B, 30B, while wiring patterns 34, 35 to lower lead-out sections 27A, 28A, respectively.

A TTP in the present invention is thus structured. Respective wiring patterns of wiring substrate 31 are coupled with a detection circuit of an electronic apparatus via connector or the like means. When upper substrate 21 is pressed from the above at a certain location with a finger tip, pen, etc., the upper substrate 21 bends, and upper conductive layer 2 makes contact with lower conductive layer 6 at the location. The pressed location is identified at the detection circuit based on ratio of resistance between upper electrodes 23 and 24, and lower electrodes 27 and 28. Ratio of resistance between upper electrodes 23 and 24 is outputted from upper lead-out sections 23A, 24A via connection electrodes 29, 30 to wiring patterns 32, 33 disposed on the reverse surface of wiring substrate 31.

Now in the following, a method for manufacturing the above-configured TTPs is described practically.

In the first place, an upper substrate 21 having on one of the surfaces a transparent upper conductive layer 2 formed through sputtering or other processes undergoes etching or laser beam cutting for selectively removing the upper conductive layer 2. A pair of upper electrodes 23, 24 as well as upper lead-out sections 23A, 24A are formed in the removed region by printing a conductive paste of silver, carbon, etc., as illustrated in FIG. 2A. Thus an upper substrate 21 is provided. Next, in the same way as in the upper substrate, lower conductive layer 6 formed on the upper surface of lower substrate 25 is selectively removed, and then lower electrodes 27 and 28, lower lead-out sections 27A and 28A, and connection electrodes 29 and 30 are provided at once by a screen printing process or the like method. Anisotropic conductive adhesive 11 is applied on the lower lead-out sections 27A, 28A and connection electrodes 29, 30 to provide a lower substrate 25 as shown in FIG. 2B. The lower substrate 25 and the upper substrate 21 are attached together by gluing the outer circumference via frame-shaped spacer 9, so that upper lead-out sections 23A, 24A oppose to the left connection parts 29A, 30A, respectively. And then, wiring substrate 31 is placed so that the wiring patterns 32, 33 are on the right connection parts 29B, 30B, and the wiring patterns 34, 35 on lower lead-out sections 27A, 28A, respectively. As the final step, upper lead-out sections 23A, 24A of upper substrate 21, and wiring patterns of wiring substrate 31 disposed in the cut 21A of upper substrate 21 are heat-pressed altogether. The upper lead-out sections 23A, 24A are glued and connected to the left connection parts 29A, 30A, the wiring patterns 32, 33, 34 and 35 to the right connection parts 29B, 30B and lower lead-out sections 27A, 28A, respectively, by the anisotropic conductive adhesive 11 to provide a finished TTP as shown in FIG. 1.

As described in the above, a lower substrate 25 in the present embodiment is provided with a pair of connection electrodes 29, 30 in an area opposing to upper lead-out sections 23A, 24A. One end of the connection electrodes 29, 30, or the left connection parts 29A, 30A, are glued and connected to upper lead-out sections 23A, 24A, while the other end, or the right connection parts 29B, 30B, and lower lead-out sections 27A, 28A are glued and connected to wiring patterns 32, 33, 34 and 35, respectively, for forming a TTP. Namely, each part of the total structures of the TTP is formed of integration of two constituent components; namely, upper substrate 21 and lower substrate 25, and wiring substrate 31 and lower substrate 25. This structure results in an easy location aligning between the components, rendering the assembly operation easier and simpler.

Furthermore, since it employs a wiring board 31 that has a plurality of wiring patterns only on the reverse surface and no through hole, TTPs can be manufactured easily for a lower cost.

An upper substrate 21 in the present embodiment is provided with a cut 21A in a region corresponding to lower lead-out sections 27A, 28A and the other end of connection electrodes, or the right connection parts 29B, 30B. A wiring substrate 31 is placed in the cut.

In the above-configured structure, there is no need of sandwiching a wiring substrate 31 between upper substrate 21 and lower substrate 25. This further makes the assembly operation easier.

Furthermore, the gluing and connecting with heat and pressure in the present embodiment is conducted between two component items, viz. between upper substrate 21 and lower substrate 25, and between wiring substrate 31 and lower substrate 25. As a result, the temperature can be kept even among the components, and a stable gluing and connecting is implemented with the anisotropic conductive adhesive.

Furthermore, since the gluing and connecting operation in the present embodiment is carried out by placing wiring substrate 31 and upper substrate 21 on lower substrate 25 and then heat-pressing the upper and lower lead-out sections, connection electrodes and wiring patterns altogether with an anisotropic conductive adhesive 11, inexpensive TTPs can be manufactured with ease.

In addition, a reinforcement layer may be provided by applying an adhesive agent for reinforcement in the vicinity of the gluing and connecting area, on at least one of the upper substrate 21 and the lower substrate 25, or the wiring substrate 31 and the lower substrate 25. When a wiring substrate 31 is connected with a connector the wiring substrate may be affected by an external force; the reinforcement layer is advantageous in protecting it from the external force and enhancing the connecting strength. Although the above descriptions have been based on a lower substrate 25 which is made of a glass or a resin having a certain rigidity, it may be formed of a flexible film of PET, PC, etc. in the same way as in the upper substrate 21.

### INDUSTRIAL APPLICABILITY

An easy-to-assemble and inexpensive TTPs are implemented in accordance with the present invention. The present invention also discloses a method for manufacturing such TTPs.

1. A transparent touch panel comprising
a transparent upper substrate having on the reverse surface a transparent upper conductive layer and an upper electrode extending from both sides of said upper conductive layer, extension of which electrodes forming a pair of upper lead-out sections at an end,
a transparent lower substrate having on the upper surface a transparent lower conductive layer opposing to said upper conductive layer with a certain specific clearance and a lower electrode extending from both sides of said lower conductive layer in the direction perpendicular to said upper conductive layer, extension of which electrodes forming a pair of lower lead-out sections at an end, and
a wiring substrate having on the reverse surface a plurality of wiring patterns, which wiring patterns being glued and connected to said upper substrate or said lower substrate with an anisotropic conductive adhesive; wherein
said lower substrate is provided with a pair of connection electrodes opposing to said upper lead-out sections, one end of said connection electrodes being glued and connected to said upper lead-out sections, while the other end of said connection electrodes and said lower lead-out sections being glued and connected to said wiring patterns of said wiring substrate.

2. The transparent touch panel of claim 1, wherein
said upper substrate is provided with a cut in a region opposing to said lower lead-out sections and the other ends of said connection electrodes.

3. The transparent touch panel of claim 1, further comprising a reinforcement adhesive layer disposed in the vicinity of gluing and connecting area, in at least one of said upper substrate and said lower substrate, or said wiring substrate and said lower substrate.

4. A method for manufacturing a transparent touch panel of claim 1, comprising the steps of
overlaying said wiring substrate and said upper substrate on said lower substrate, and then
press-heating said upper and lower lead-out sections, said connection electrodes and said wiring patterns for gluing and connecting with an anisotropic conductive adhesive.
